(19) United States
(12) Patent Application Publication
(10) Pub. No.: US 2008/0053279 A1
(43) Pub. Date: Mar. 6, 2008

(54) Adjustable spanner for preventing nut from rounding apex

(76) Inventor: Arthur Wu, Taichung Hsien (TW)

Correspondence Address: ARTHUR WU, 235 Chung-Ho, Box 8-24, Taipei, omitted

(21) Appl. No.: 11/515,186

(22) Filed: Sep. 5, 2006

(51) Int. Cl. B25B 13/16

(52) U.S. Cl. 81/170; 81/165; 81/186

(57) ABSTRACT

An adjustable spanner comprises a handle; one end of the handle having an enlarged head; an upper side of the head being formed with a sliding surface; a fixing jaw extended from one end of the head; the fixing jaw having a fixing surface; a fixing protrusion being formed at a lower side of the fixing surface; a movable jaw installed in the sliding trench; the movable jaw having a movable surface; a directional control element being installed in the receiving groove and engaged to the movable jaw; a movable protrusion being formed at a lower side of the movable surface; a line being defined from a top end of the fixing surface to the sliding surface; a line X being defined to be an axial line of the sliding trench, the angel Θ between the line Y and the line X is between 65°˜85°, preferably is 74°.

### FIELD OF THE INVENTION

The present invention relates to adjustable spanners, and particularly to an adjustable spanner for preventing a nut from rounding apexes.

### BACKGROUND OF THE INVENTION

An adjustable spanner has two jaws for clamping a nut. Generally, in operation, the apex of the nut will round in operation. Thus there are many designs for improving above mentioned defects, which are for example, U.S. Pat. No. 5,878,636, U.S. Pat. No. 3,916,735, U.S. Pat. No. 191,892, U.S. Pat. No. 5,152,198, U.S. Pat. No. 1,632,911, U.S. Pat. No. 1,309,860, and Taiwan Patent 302793, and U.S. Pat. No. 6,848,343. Taiwan Patent 302793, and U.S. Pat. No. 6,848,343 are invented by the inventor of the present invention, in that inner surfaces of the jaws are formed with protrusions and recesses.

In above mentioned structure, the designs are only suitable for some specific nuts, they can not be used to various nuts of different specifications. However, the adjustable spanner is used for various nuts of different specifications, and thus the above mentioned designs are not suitable for the adjustable spanner. The nuts have different sizes, pitch, helix angle, etc. However, the adjustable spanner must be suitable for these nuts. The recesses in the inner surfaces of the two jaws of an adjustable spanner cannot make apexes of nuts of different specifications falling into the recesses. Thus, the apexes of the nuts are possibly rounded by the wearing from the jaws.

### SUMMARY OF THE INVENTION

Accordingly, the primary object of the present invention is to provide an adjustable spanner which comprises a handle; a receiving groove being longitudinally penetrating through the handle; one end of the handle having an enlarged head; an upper side of the head being formed with a sliding surface; the head having a transversal sliding trench; the sliding trench communicated to the receiving groove; a fixing jaw extended from one end of the head; the fixing jaw having a fixing surface; a fixing protrusion being formed at a lower side of the fixing surface; a movable jaw installed in the sliding trench; the movable jaw having a movable surface; a directional control element being installed in the receiving groove and engaged to the movable jaw; a movable protrusion being formed at a lower side of the movable surface; a line being defined from a top end of the fixing surface to the sliding surface; a line X being defined to be an axial line of the sliding trench, the angel Θ between the line Y and the line X is between 65°˜85°.

The various objects and advantages of the present invention will be more readily understood from the following detailed description when read in conjunction with the appended drawing.

### BRIEF DESCRIPTION OF THE DRAWINGS

FIG. 1 is a perspective view of the adjustable spanner of the present invention.

FIG. 2 is a plane view of the adjustable spanner of the present invention.

FIG. 3 is a schematic view showing the operation of the present invention, where the present invention is used to clamp a great nut.

FIG. 4 is a schematic view showing the operation of the present invention, where the present invention is used to clamp a middle nut.

FIG. 5 is a schematic view showing the operation of the present invention, where the present invention is used to clamp a small nut.

FIG. 6 is a schematic view showing that the adjustable spanner of the present invention clamps a nut.

FIG. 7 shows the nut in FIG. 6 being rotated through one angle.

FIG. 8 shows the nut illustrated in FIG. 6.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

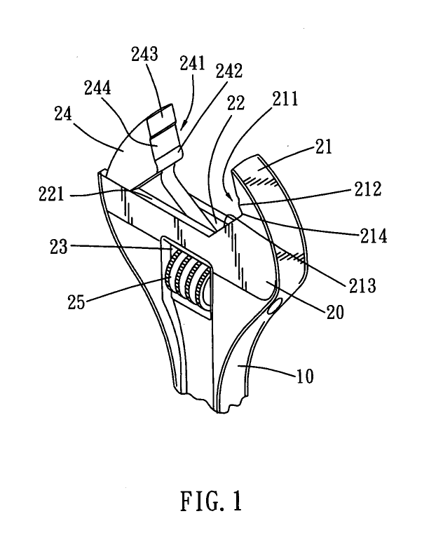

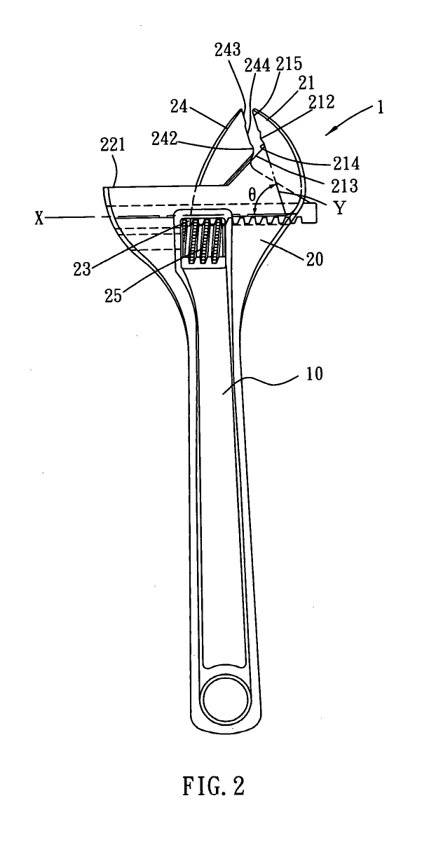

Referring to FIGS. 1 and 2, the jaw structure of an adjustable spanner of the present invention is illustrated. The present invention has the following elements.

A body 1 has handle 10. A receiving groove 23 longitudinally penetrating through the handle 10.

One end of the handle 10 has an enlarged head 20. One end of the head 20 is extended with a fixing jaw 21. An upper side of the head 20 is formed with a sliding surface 22. The head 20 has a transversal sliding trench 22. The sliding trench 22 is communicated to the receiving groove 23.

A movable jaw 24 is installed in the sliding trench 22. A directional control element 25 is installed in the receiving groove 23 and is engaged to the movable jaw 24. When the directional control element 25 is rotated, the movable jaw 24 is driven to move long the sliding trench 22 so as to change the distance between the fixing jaw 21 and movable jaw 24. However, above mentioned structure is known in the prior art. The directional control element 25 may be for example a worm rod as shown in the drawing, or a button or a wedge member, etc.

The main feature of the present invention is that a fixing surface 211 of the fixing jaw 21 and a movable surface 241 of the movable jaw 24 facing to the fixing surface 211 are parallel. A cambered or trapezoidal protrusion 212 is formed at a lower side of the fixing surface 211. A receiving recess 214 is formed at a lower side of the fixing surface 211 for receiving an apex B of a nut. An inclined resisting surface 213 is formed between the recess 214 and the sliding surface 22 for resisting a nut.

A cambered or trapezoidal movable protrusion 242 is formed at a lower side of the movable surface 241. The movable surface 241 has a long recess 244 between the protrusion 242 and the movable surface 241 for receiving an apex B1 of a nut. A line Y is defined from a top end of the fixing surface 211 to the sliding surface 22. A line X is defined to be an axial line of the sliding trench 22. In the present invention, the angel Θ between the line Y and the line X is less than 90 degrees, preferably, between 65°˜85°. More preferably, it is 74°.

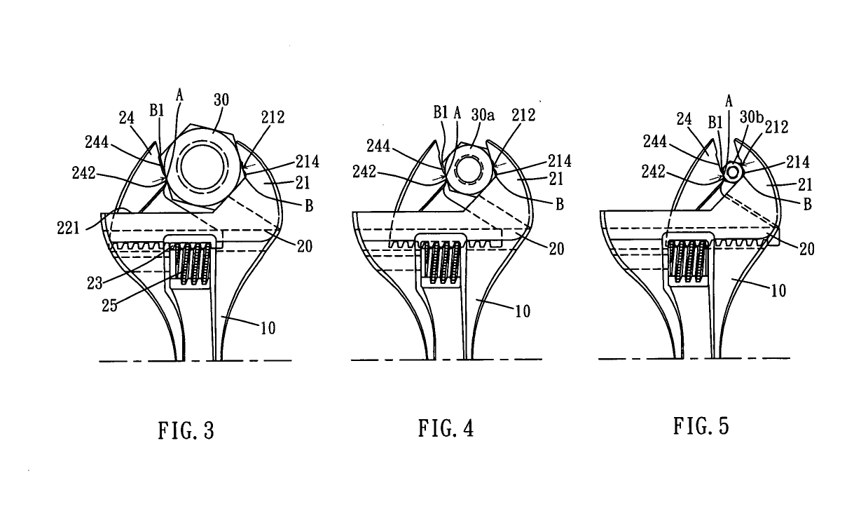

Referring to FIG. 3 to 5, the movable protrusion 242 can resist a center position of an edge A of a great nut 40, a middle nut 30a and a small nut 30b.

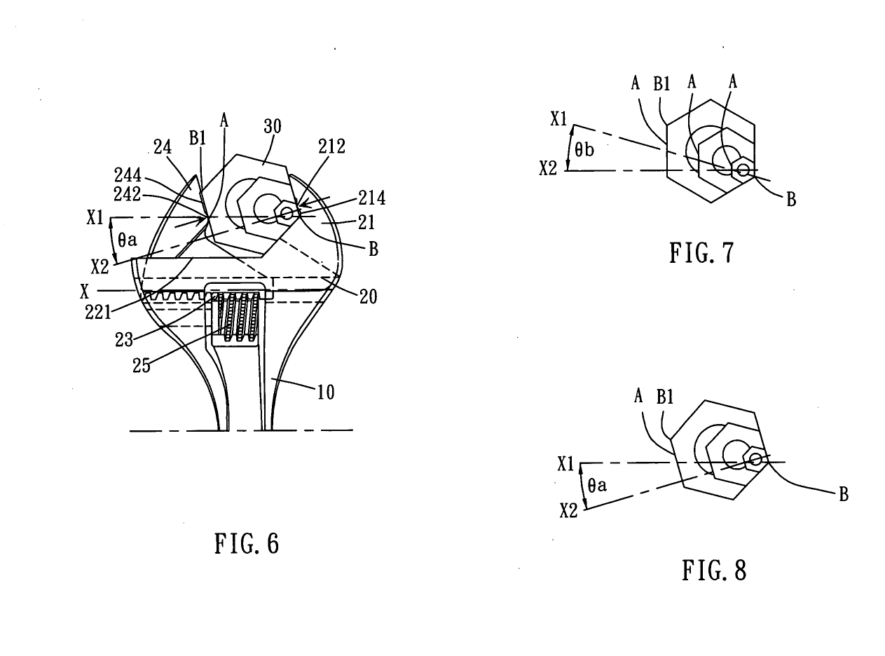

Referring to FIG. 6 to 8, a line X2 is vertical to an edge A of a nut as the nut is placed between the two jaws with one side resisting against the fixing jaw 21 and one side resisting against the resisting surface. A line X1 passing one corner B of the nut. When the angle Θ is 74°, the angle Θb between the line X1 and X2 is 16°.

Referring to FIGS. 6 and 8, in FIG. 7, it is illustrated that the nut is rotated through 16 degrees from the orientation in FIG. 8. The movable protrusion 242 still resists against at a center position of the edge A.

In above design, the apexes B, B1 are in the recesses 214, 244, as illustrated in FIGS. 3 to 5. Thus the apexes 214, 244 are not in contact with the spanner. Thus the apexes will not be damaged.

Advantages of the present invention are that: the apexes of the nut will not round. Thereby for the nut with rounded apex, the spanner of the present invention can drive it well.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. An adjustable spanner comprising:
a handle; a receiving groove being longitudinally penetrating through the handle;
an enlarged head at one end of the handle; an upper side of the head being formed with a sliding surface; the head having a transversal sliding trench; the sliding trench communicated to the receiving groove;
a fixing jaw extended from one end of the head; the fixing jaw having a fixing surface; and a fixing protrusion being formed at a lower side of the fixing surface;
a movable jaw installed in the sliding trench; the movable jaw having a movable surface; a directional control element being installed in the receiving groove and engaged to the movable jaw; a movable protrusion being formed at a lower side of the movable surface; a line Y being defined from a top end of the fixing surface to the sliding surface; a line X being defined to be an axial line of the sliding trench, the angel Θ between the line Y and the line X is between 65°˜85°; and
wherein the movable protrusion has a cambered or trapezoidal shape:
wherein the fixing protrusion has a cambered or trapezoidal protrusion:
wherein a receiving recess is formed at a lower side of the fixing surface for receiving an apex of a nut: and an inclined resisting surface is formed between the recess and the sliding surface for resisting a nut; and
wherein the movable surface has a long recess between the protrusion and the movable surface for receiving an apex of a nut.

2. The adjustable spanner as claimed in claim 1, wherein the angel θ is 74°.

3. The adjustable spanner as claimed in claim 1, wherein a fixing surface of the fixing jaw and a movable surface of the movable jaw facing to the fixing surface are parallel.

4. (canceled)

5. (canceled)

6. (canceled)

7. (canceled)
